(19) United States
(12) Patent Application Publication
(10) Pub. No.: US 2008/0205248 A1
(43) Pub. Date: Aug. 28, 2008

(54) Optimization Spherical Aberration to Determine Current Layer

(75) Inventors: Edwin Johannes Maria Janssen, Eindhoven (NL); George Alois Leonie Leenknegt, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,052

(22) PCT Filed: Jun. 27, 2006
(86) PCT No.: PCT/IB06/52119

§ 371 Date: Dec. 27, 2007

Related U.S. Application Data
(60) Provisional application No. 60/695,086, filed on Jun. 29, 2005.

(51) Int. Cl. G11B 7/135

(52) U.S. Cl. 369/112.23

(57) ABSTRACT

A spherical aberration correction mechanism is optimised early in the start-up process by measuring responses for various settings of the spherical aberration correction device that are removed from the initial settings of the spherical aberration correction by small amounts and comparing these responses with those anticipated for various of the multiple layers on the optical media. Signal measurements and calibrations can be performed prior to attempting to read data from the disc or concurrently with reading data from the disc. Comparing the responses with ideal, typical or anticipated curves for the various layers can derive the address of the current layer and the desired layer can be immediately accessed.

The present invention relates optical disc recognition and, more particularly, to recognition of layer information within optical discs.

Recently developed optical disc players/recorders can typically operate with various types of optical discs. Once a disc is placed into an optical disc players/recorder, the optical disc players/recorder must first determine the disc type. In disc players/recorders that operate with one of the more recent disc formats, such as HD-DVD or Blu-ray disc (BD), layer information for the disc, such as single or dual layer information, can be retrieved by reading out the control data zone for DVD discs or the information zone for BDs. Conventionally, these types of player/recorders can retrieve layer information by performing a complex algorithm that recognizes the disc by measuring and calibrating signals coming from the disc and initializing HF and wobble phase lock loops.

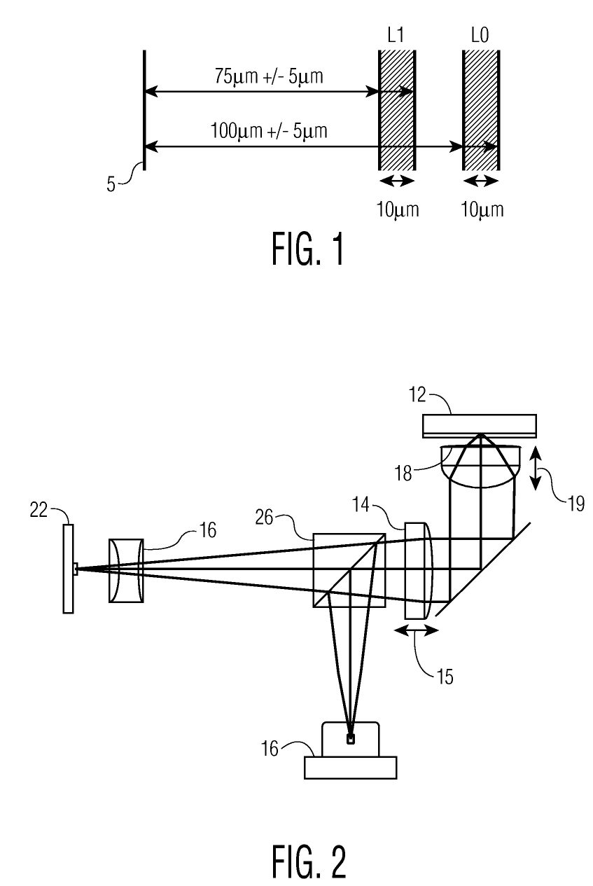

Currently existing BD multi-layer discs have 2 recording layers. The recording layer, referred to herein as L1, is present at a distance of about 75 μm from the cover layer as shown in FIG. 1. The recording layer, referred to herein as L0, is situated at a distance of about 100 μm from the cover layer, also as shown in FIG. 1. Both the L0 and L1 recording layers are about 10 μm thick. As clearly evident from FIG. 1, the cover layer is much thicker than either recording layer L0 or L1. Variation in the thickness of the cover layer introduces spherical aberration in focusing on the recording layers L0, L1 that requires compensation. One manner for compensating is these variations, is via a movable collimator lens.

Layer information within a multi-layer disc, such as current layer being focused upon, can be retrieved by reading out information on the disc related to the current layer. This information for the current layer in case of DVD or BD can be obtained by reading a header or ADIP addresses (ADdresses In the Pregroove, otherwise referred to as wobbling addresses).

Reading addresses can be accomplished at a late stage within the start-up procedure once servo, HF and wobble signals can be correctly obtained and are of decent quality.

Start-up as used herein generally refers to initialisation procedures that occur once a disc is placed into a player/recorder begins to use the disc. At start-up, various factors related to type of disc are unknown. Start-up for multi-layer discs, especially within player/recorders that can operate with different types of optical media, presents numerous unknown factors. Among these unknown factors at start-up is whether the disc type is a single layer or multi-layer disc. In BD types of media, the substrate thickness has a major influence on signal quality. Upon start-up for BD types of media that have multiple recording layers, the player/recorders will conventionally have mechanisms that correct for spherical aberrations in accordance with the current layer that is being focused upon. These mechanisms that correct for spherical aberrations are typically preset to a position that is between the optimum values desired for focusing on either of the layers within the optical media. Commonly employed mechanisms that correct for spherical aberrations are a collimator lens mounted on a motor and liquid crystal spherical aberration correction mechanisms.

For example, in multi-layer BD optical media types, there are currently 2 layers. One type of spherical correction mechanism that is used is a collimator lens mounted on a motor to move the optics associated with the collimator lens to correct for spherical aberrations, generally referred to as a collimotor. Typically at start-up, systems employing a collimotor is preset in the middle position for the optimum values of the two layers of a dual layer disc. This middle position is calculated from the stored optimal position for both layers, preset in the factory, or learned during normal use or a combination of both. As a result of the mechanism that corrects for spherical aberrations not being set to an optimum value for any of the recording layers, the quality of the resulting servo signals for focus and tracking are not optimal. The rationale for placing the mechanism for correcting spherical aberrations in between optimum values is that the servo control signals for focus and tracking will be close to both the layers of a BD dual layer disc. For example, in the case of a collimator lens, the position is set to the middle position between the 2 layers. In the case where a liquid crystal device is used to adjust as the spherical aberration correction mechanism that is used to adjust the wavefront from that is focused on the optical media, a similar rational is commonly used, i.e. no optimum value for either layer initially exists at start-up.

Once that layer information is known, the spherical aberration correction mechanism if collimator lens can be moved towards the optimum position of that layer. In the case of a liquid crystal spherical aberration correction mechanism, bias voltages can be adjusted to modify the optical characteristics in a manner know within the art. The settings and parameters will then be adapted and specifically set for optimal performance of that specific layer. Typically, these calibrations will be repeated to determine optimum signal quality.

A problem that exists within the above-discussed procedures is that too much time is spent during start-up before layer information is sufficiently known. Currently during start-up for multi-layer discs, the spherical aberration correction mechanism is not optimised. If the spherical aberration correction mechanism is a collimator-lens set up, the collimator lens is moved into a predetermined position that is not optimised for a specific layer. If the spherical aberration correction mechanism is a liquid crystal based device, the liquid crystal device is set to a predetermined setting that is not optimised for a specific layer. The optical-head will typically use the focus-error signal to search for a layer, and the drive will attempt to read factory written, optimum spherical aberration correction mechanism setting from the layer. Therefore, there remains a need within the art for a system and method that can provide layer information earlier within the start-up process and allow parameters specific to that layer to be implemented.

The foregoing shortcomings within the prior art are addressed by the embodiments disclosed herein that can be applied to both collimator and liquid crystal spherical aberration correction mechanisms. The embodiment discussed herein can optimise the spherical aberration correction mechanisms. The embodiments disclosed herein can optimise spherical aberration correction mechanisms using either push pull or dpd modulation prior to or concurrently with reading data from the disc much earlier in the start-up process. The signal measurements and calibrations can then be performed prior to attempting to read data from the disk. The embodiments provide these features by comparing the initial responses from the spherical aberration correction mechanisms with a typical, ideal or anticipated response curve, allowing extremely quick determination of the layer that is being focus upon. Once the current layer is known, the desired layer can be immediately accessed.

FIG. 1 is a diagram illustrating multiple layers within an optical media;

FIG. 2 is a diagram illustrating optical with a optical disc player/recorder; and

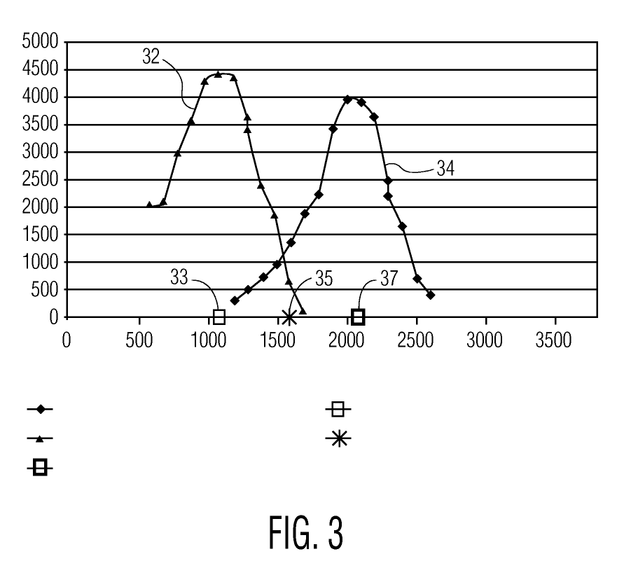

FIG. 3 is a diagram of illustrating curves for push pull amplitude for different spherical aberration correction setting for multiple layers within a disc.

If a spherical aberration correction mechanism is not set to an optimal value that is specific for the layer that is currently being focused on, the focus and radial loops cannot be used effectively. Many signal optimization procedures can then result in reasonable hf and wobble quality, which allows address readout. At this stage the spherical aberration can be set to the correct position for the current layer. By optimising the spherical aberration corrector as soon as focus is captured (towards e.g. maximal push pull or dpd amplitude), all signal measurements and calibrations can already be done with the correct spherical aberration settings. Time can be saved which results in speeding up the disc recognition.

An embodiment employs layer information detection as a result of optimization of the spherical aberration corrector. The earlier in the start-up process that layer information is known, the earlier many decisions can be made. Tracks are typically recorded in one of two different modes called Parallel Track Path (PTP) or Opposite Track Path (OTP). In PTP mode, tracks are read from the inside diameter of the information area on the disc towards the outside diameter for both Layer 0 and Layer 1. OTP is a standard that can be employed in dual-layer BD and DVD types of media which defines layer L0 as being written in a spiral track starting at the inside of the disc, and layer L1 having a spiral track which starts at the outside of the disc. Using OTP, the tracks are written so that the player/recorder rotates in the same direction for accessing each layer. OTP enables the player/recorder to switch from one layer to the other more quickly. In addition to track direction (such as OTP or PTP), earlier layer information knowledge within the start-up process allows for calibrations and settings so that layer specific content can be executed for the layers.

In an embodiment, an optical media player/recorder system is capable of reading multiple types of optical media including optical media having multiple layers, the optical media player/recorder has a spherical aberration correction mechanism that corrects for spherical aberrations. The layer information is obtained in an earlier stage within the start-up process by performing an optimization of spherical aberration towards maximum push-pull modulation for the layer that is being focused upon. The targeted position of the spherical aberration correction needs to be very specific due to the spherical aberration that occurs as a result of the cover layer thickness. This is achieved in this embodiment by initially focusing on the optical media and the current to which the optics are set. The focus and the mechanism for correcting spherical aberration are adjusted in a first direction and measurements are made of the response to the adjustment. The focus and the mechanism for correcting spherical aberration are adjusted in a second direction opposite the first direction and measurements are made of the response to the adjustment. From these measurements, a response curve is established and compared with an anticipated response curve for each of the recording layers. A determination is made of the layer that matches the response curve that is closest as a result of the comparison and the player/recorder implements the settings and parameters that are specifically desired for this layer. Once the current layer is known, the system can proceed to operate on the various layers on the optical media using settings and parameters that are specifically optimized for those layers. The results are that optimum spherical aberration correction occurs much earlier in the start-up process than in conventional methods as previously discussed.

In another embodiment, a collimator lens position is used as the mechanism for correcting spherical aberration. The positioning of the collimator lens needs to be very specific due to the spherical aberration that occurs as a result of the cover layer thickness. FIG. 2 is a schematic view of optical system 10 used within in a BD-drive that employs a moving collimator lens (collimotor). FIG. 2 illustrates a type of optical system 10 employed within the drives used to read and record a Blu-ray disc 12. In a Blu-ray system as illustrated in FIG. 2, a 450 nm light emanates from Blu-ray laser 16 which has a substantial portion reflected from beam splitter 26 through collimator lens 14. The collimator lens 14 takes the light incident from the beam splitter 26 and forms a more or less parallel light that is incident upon mirror 24. Mirror 24 reflects the ‘parallel’ light towards objective lens 18; which focuses the light beam on disc 12. Light reflected from disc 12 is formed into parallel light by objective lens 18. The focal position of objective lens 18 is controlled by focus offset servo 19. Light reflected from the disc passes through objective lens 18 and is reflected by mirror 24 through collimator lens 14. The reflected light beam that passes through collimator lens 14 converges towards beam splitter 26 which passes a substantial portion to servo lens 22 and onto detector 22.

The spot on the disc can be defocused by actuating focus offset servo 19 which moves the objective lens 18 relative to the disc in the direction indicated by arrow 19. Changing the position of the collimator lens 14 by collimotor servo 15 can make the light beam diverge or converge, as desired, creating at least a partially, non-parallel beam. This non-parallel beam generates additional spherical aberration in the objective lens. This adds to the spherical aberration generated by the mismatch between the objective lens 18 and the cover layer thickness of the disc.

The BD-standard allows each layer on the BD disc 12 to deviate 5 μm from the nominal values for the layer L0 (100 μm) and layer L1 (75 μm) as illustrated in FIG. 1. Although read-out is possible up to 8 μm spherical aberration compensation servo, or SA-servo error, such a large margin leaves virtually no margin to compensate for other degradations within the drive or on the disc.

In order to keep the design of a BD drive economical, conventional 4-segment photo-diode detector elements are commonly used for focus-error and radial tracking-error signal generation. To require more complicated photo diode detector elements to measure the spherical aberration would result in an unacceptable increase in costs to the system. Therefore, in order to keep system costs down, it is desirable to employ conventional 4-segment detector elements without using additional detectors. As a result, currently available BD-drive architectures are not capable of providing direct error signals to enable control of the cover layer thickness compensation servo (also referred as spherical aberration compensation servo, or SA-servo).

In optical disc systems that read from a ROM disc, the focus offset and SA-servo can be optimized using the jitter of the read HF-signal. However, on blank recordable discs, like BD-R, rewritable BD-RE or DVD+R, no data is available from which to generate the HF-signal. Therefore, a problem exists in optimizing the focus offset and SA-servo during start-up within blank recordable and rewritable optical discs.

Conventional Blu-ray disc writing systems do not guarantee the presence of an HF-signal. These currently available Blu-ray writing systems typically employ a push-pull methodology for SA-servo optimization. A common practice is to optimize the SA-servo during start-up by measuring the Push-Pull amplitude or Push-Pull power. Push-pull optimization results in a setting that is sufficiently accurate to enable further optimizations.

FIG. 3 illustrates a graph for BD systems that use collimator lens positioning to correct for spherical aberrations that occurs as a result of the cover layer. FIG. 3 illustrates representative positioning of the collimator lens 14 by collimotor servo 15 to correct for these spherical aberrations in focusing on both the L0 and L1 recording layers. As clearly evident from FIG. 3, a large difference exists between the collimator position used for the L0 and L1 layers. In the BD drive that use collimator lens 14 positioning as shown in FIG. 3, the movement of the collimator lens 14 can cover a distance of over 3800 μm, with the optimum position of L1 recording layer being at 2175 μm and the optimum position of for the L0 recording layer being at 1175 μm. This difference of 1000 μm in collimator position is required to compensate for the change in the spherical aberration that result from the 25 μm difference in distance from the surface of the cover layer that exits between the L0 and L1 recording layers. This 25 μm difference can be viewed as an additional 25 μm thickness in the cover layer for the L0 recording layer.

The optimum collimator position for each layer of every each disc type supported by the player/recorder is preset during production to a default value. The default values are monitored and averaged during start-up. By adjusting the collimator 15 such that the collimator lens is moved in very small increment towards and away from the optical media, measuring the response values detected for each position and comparing the response values against those stored for both layers, a reliable assumption of the current layer can be obtained and information that is specific for that layer can be made available either by reading the information from the layer itself or using information that is stored within the play/recorder. It is envisioned that a second order curve fit on the valid measured parameters will result in an optimal determination of which curve in FIG. 3 match the responses that are being received and the current layer that is being focused upon. Comparing responses positions that are common for cover layer thicknesses, so for specific layers, the current layer can be determined

Another embodiment employs a liquid crystal based device as the spherical aberration correction mechanism. To implement a system with a liquid crystal based device as the spherical aberration correction mechanism, the circumstances and arrangements are similar to that discussed above in relation to FIGS. 2 and 3 by changing the collimator lens 14 to a liquid crystal device (not shown) and changing the overall collimator servo 15 to the respective electronics that control the liquid crystal device. In this embodiment, a set of curves will be stored within the layer/recorder similar to those illustrated in FIG. 3. At start-up, the liquid crystal device is set to a predetermined setting that is not optimised for a specific layer. The electronics that control the liquid crystal device will alternately change the settings for the liquid crystal device for focus a small amount closer and a small amount farther. The response of these adjustments is measured and compared against the set of curves will be stored within the layer/recorder in a manner similar to that described above for the collimotor 15. The player/recorder can then match the measured response to the internally stored curves to determine exactly which layer is currently being focused upon.

These and other objectives are achieved by determining the current layer by focussing on an unknown layer, altering the current spherical aberration correction mechanism focus at closer and farther distances using either push-pull or Differential Phase Detection (dpd), response amplitudes are measured for both closer and farther focus distances. A curve fit is made by matching actual response with anticipated responses for the layers contained on the disc. A second order curve fit between the received responses to the altering of the spherical aberration correction mechanism for focusing at closer and farther distances and anticipated curves for each of the layers results in an optimal value for the setting of the spherical aberration correction mechanism. In a two layer BD media as previously discussed, the curve generated from the measured responses to the spherical aberration correction mechanism focusing at closer and farther distances will look like one of the two curves illustrated FIG. 3. This curve is situated around a collimator position for embodiment employing a collimator lens for the spherical aberration correction mechanism or around the settings and biases for a liquid crystal device in embodiments employs a liquid crystal device as the spherical aberration correction mechanism. The curve is then specific for one of the layers. By comparing this optimal position with positions that are common for cover layer thicknesses for the specific layers, the current layer can be determined

FIG. 3 is a diagram of illustrating curves for push pull amplitude for different collimator position for multiple layers within a disc. FIG. 3 illustrates measurements for a L1 curve 32 that is representative of a pushpull amplitude for the L1 layer within a BD type optical media. L1 curve 32 has a maximum amplitude at collimator position 33 which is the L1 curve 32 optimization pushpull amplitude. L0 curve 34 illustrates measurements for a L0 curve 34 that is representative of a pushpull amplitude for the L0 layer within a BD type optical media. L0 curve 32 has a maximum amplitude at collimator position 37 which is the L0 curve 34 optimization pushpull amplitude. The L1 32 and L0 34 curves cross at collimator position 35. As previously discussed, movement of the collimator position left and right along the X axis shown in FIG. 3 and measuring the response to these movements allows for curve matching between the actual responses and either the L1 32 and L0 34 curves. Once the curve match is made, the current layer being focused upon is known, the parameters and settings that are specific for that layer can be made. While the foregoing discussion related to collimator positioning on a BD type media, it will be readily apparent to those skilled within the art that these foregoing concepts can be applied to other types of media such as DVD types of media and newer high density types of DVD media. It will be further readily apparent to those skilled in the art that a liquid crystal mechanism can be employed as the spherical aberration correction mechanism and the collimator positions can be placed with setting for the liquid crystal mechanism. The foregoing comparisons can be made towards stored, learned, and optimal positions as well as from factory presets or previous successful disc recognitions. These procedures can be implemented in all types of optical storage products that require a correction for spherical aberration introduced by cover layer thickness variations and multi-layer discs.

1. A method focusing on an optical media player/recorder system capable of reading multiple types of optical media including optical media having multiple layers, the optical media player/recorder having a spherical aberration correction mechanism that corrects for spherical aberrations comprising:
focusing a radiation beam on an unknown layer within an optical media;
adjusting the spherical aberration correction mechanism for focusing in a first direction away from the unknown layer;
measuring a first response after adjusting in the first direction;
adjusting the spherical aberration correction mechanism in a second direction opposite the first direction;
measuring a second response after adjusting in the second direction;
determining a known layer from the first and second responses.

2. The method of claim 1 wherein the steps of measuring the first and second responses further comprise measuring a first and second set of responses while adjusting the spherical aberration mechanism in respective first and second directions.

3. The method of claim 1, wherein the spherical aberration correction mechanism further comprises a moveable set of optics.

4. The method of claim 3 wherein the moveable set of optics further comprises a collimator lens.

5. The method of claim 1, wherein determining further comprises comparing the first and second responses with a set of curves that represent anticipated responses from focusing around layers on the optical media.

6. The method of claim 5, wherein determining further comprising adjusting the spherical aberration correction mechanism for optimized push-pull modulation in accordance with the known layer.

7. The method of claim 6, wherein the spherical aberration correction mechanism is optimized for each layer on the optical media prior reading out data from the optical disc.

8. The method of claim 1, wherein the spherical aberration correction mechanism further comprises a liquid crystal device.

9. The method of claim 1, wherein determining further comprises matching a response curve determined by the first and second responses to a set of anticipated curves for the spherical aberration correction mechanism.

10. The method of claim 9 wherein the matching is a second order curve fit of the response curve determined by the first and second responses to a set of anticipated curves for the spherical aberration correction mechanism.

11. An optical media player/recorder system capable of reading multiple types of optical media including optical media having multiple layers, the optical media player/recorder system including a spherical aberration correction mechanism that corrects for spherical aberrations comprising:
optics that focus a radiation beam on an unknown layer within an optical media;
an adjusting device for the spherical aberration correction mechanism for focusing in a first direction away from the unknown layer and in a second direction opposite the first direction;
a detector that measures a first response after focusing in the first direction and a second response after adjusting in the second direction;
a determination system within the optical media player/recorder system that determines a known layer from the first and second responses.

12. The system of claim 11 wherein the detector of the first and second responses further detects a first and second set of responses while adjusting the spherical aberration mechanism in respective first and second directions.

13. The system of claim 11, wherein the spherical aberration correction mechanism further comprises a moveable set of optics.

14. The system of claim 13 wherein the moveable set of optics further comprises a collimator lens.

15. The system of claim 11, wherein the determination system further comprises a comparison mechanism that compares the first and second responses with a set of curves that represent anticipated responses from focusing around layers on the optical media.

16. The system of claim 15, wherein the determination system further comprises an adjustment mechanism that can adjust the spherical aberration correction mechanism for optimized push-pull modulation in accordance with the known layer.

17. The system of claim 16, wherein the spherical aberration correction mechanism is optimized for each layer on the optical media prior reading out data from the optical disc.

18. The system of claim 1, wherein the spherical aberration correction mechanism further comprises a liquid crystal device.

19. The system of claim 1, wherein the determination mechanism further comprises a response curve matching mechanism that matches curves determined by the first and second responses to a set of anticipated curves for the spherical aberration correction mechanism.

20. The system of claim 19 wherein the response curve matching mechanism further comprises a second order curve fit of the response curve determined by the first and second responses to a set of anticipated curves for the spherical aberration correction mechanism.
